(19) United States
(12) Patent Application Publication
(10) Pub. No.: US 2017/0053205 A1
(43) Pub. Date: Feb. 23, 2017

(54) SYSTEM AND METHOD FOR TRACKING KNOWLEDGE AND EXPERTISE

(71) Applicant: Whoknows, Inc., Mountain View, CA (US)

(72) Inventor: Toufic SALIBA, Mountain View, CA (US)

(21) Appl. No.: 15/346,576

(22) Filed: Nov. 8, 2016

Related U.S. Application Data
(63) Continuation of application No. 13/835,769, filed on Mar. 15, 2013.

(51) Int. Cl. G06N 5/02; G06N 99/00

(52) U.S. Cl. CPC G06N 5/022; G06N 99/005

(57) ABSTRACT

Various embodiments of the present invention relating to a knowledge expertise platform for tracking, analyzing, and sharing knowledge expertise among group member clients are disclosed. In particular, the knowledge expertise platform enables categorizing and ranking a broad universe of human learning to generate expertise categories, processing the expertise categories to accurately identify and link user consumption content to expertise information, and automatically monitoring and interpreting user content consumption to share the expertise information among member clients within a group.

### CROSS-REFERENCE TO RELATED APPLICATION(S)

This application is a continuation of U.S. patent application Ser. No. 13/835,769, entitled “SYSTEM AND METHOD FOR TRACKING KNOWLEDGE AND EXPERTISE,” filed Mar. 15, 2013, which is incorporated by reference herein in its entirety.

### BACKGROUND

Identification of knowledge and expertise within skilled groups plays a vital role in building and maintaining a robust organization. Organizations have invested great expenditures in acquiring talent, and can benefit greatly from having the right tools to identify “who knows what” among employees. An individual within an organization may know what he/she knows, but does not necessarily know what another coworker of ten years knows. The difficult lies not in the actual discovery of an expert in a particular area, but rather of the fine details related to the skills of the expert.

Many efforts have been attempted to improve the identification of skills among users within an enterprise. One common approach is through the use of peer review where limited grouping of skills are tracked within small user groups of a controlled, closed, peer-based network. For large networks and organizations, however, no scalable solution exists for tracking knowledge and expertise in an open environment, across a broad universe of skills.

### BRIEF DESCRIPTION OF THE DRAWINGS

FIG. 1 is a diagram illustrating an example environment in which one or more embodiments of the present invention may be implemented.

FIG. 2 is a block diagram of an example set of components that may be used in a knowledge expertise platform system in accordance with one or more embodiments of the present invention.

FIG. 3 is a diagram illustrating an example set of components that may be used in an interpretation module in accordance with one or more embodiments of the present invention.

FIG. 4 is a flow diagram illustrating an example process utilized by the interpretation module in accordance with one or more embodiments of the present invention.

FIG. 5 is an example illustrating a knowledge expertise platform 500 on which a client device may connect to the expertise server in accordance with one or more embodiments of the present invention.

### DETAILED DESCRIPTION

Various embodiments of the present invention relating to a knowledge expertise platform for tracking, analyzing, and sharing knowledge expertise among group member clients are disclosed. In particular, the knowledge expertise platform enables categorizing and scoring a broad universe of human learning to generate expertise categories, processing the expertise categories to accurately identify and link user consumption content to expertise knowledge, and automatically monitoring and interpreting user content consumption to share expertise knowledge among member clients within a group.

Certain implementations of the various embodiments of the present invention provide many benefits, including, but are not limited to: (1) enabling an automated, scalable solution for identifying and sharing knowledge and expertise in an open, uncontrolled environment without interfering with the actual operations of the member clients; and (2) enabling knowledge expertise categorization across a broad range of skills outside of the member client group.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

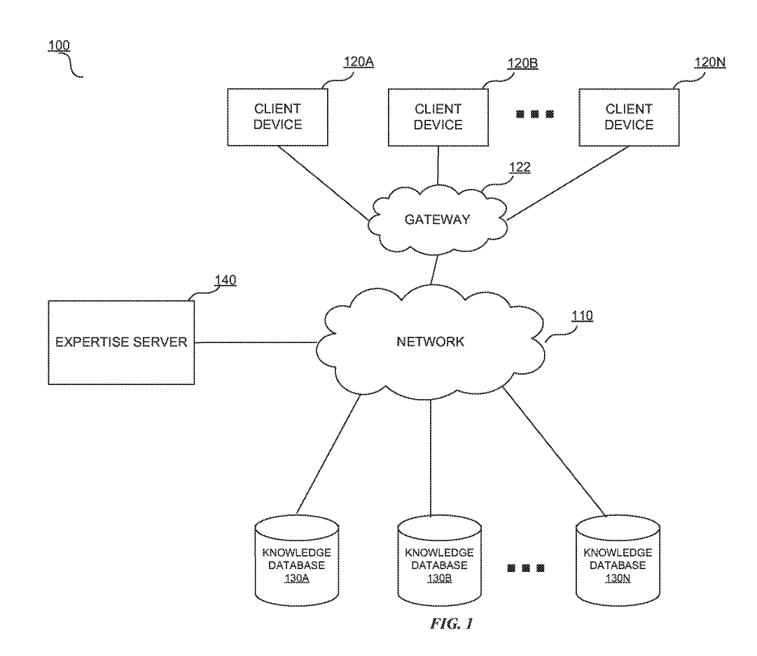

FIG. 1 illustrates a suitable environment 100 in which a knowledge expertise platform for tracking, analyzing, and sharing knowledge expertise among group member clients may be implemented. It is noted that various modifications, such as the inclusion of additional devices, consolidation and/or deletion of various devices, and the shifting of functionality from one device to another, may be made without deviating from the present invention. Environment 100 includes a network 110, client devices 120A-C, a gateway 122, various knowledge databases 130A-N, and an expertise server 140.

The network 110 is configured to interconnect various computing devices such as the client devices 120A-C and the expertise server 140 to one another and to other resources. The network 110 may include any number of wired and/or wireless networks, including the Internet, intranets, local area networks (LANs), metropolitan area networks (MANs), wide area networks (WANs), personal area networks (PANs), direct connections, and/or the likes. Additional computing devices, such as routers, network switches, hubs, modems, firewalls, gateways, Radio Network Controllers (RNCs), proxy servers, access points, base stations, and/or the likes may be employed to facilitate network communications. In addition, the various computing devices may be interconnected with T1 connections, T3 connections, OC3 connections, frame relay connections, Asynchronous Transfer Mode (ATM) connections, microwave connections, Ethernet connections, token-ring connections, Digital Subscriber Line (DSL) connections, and/or the likes. Further, the network 110 may utilize any wireless standard and/or protocol, including, but not limited to, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), and/or the likes.

The client devices 120A-N may be any computing device (e.g., a general-purpose computer, a mobile device, etc.) capable of receiving and sending data over a network, such as the network 110. The term “general-purpose computer,” as used herein, may be a desktop computer, a laptop, a multiprocessor system, a microprocessor-based or programmable consumer electronic device, a television, a digital video recorder, a media center device, a set-top box, other interactive television device, and/or the likes. The general-purpose computer typically includes a processing unit, a memory, a power supply, one or more network interfaces, a display, a keypad or a keyboard, and other input/output interfaces. The memory in the general-purpose computer generally includes computer storage media for storing information such as computer readable instructions, data structures, program modules, or other data. In addition, the memory may be employed to store operational data, content, contexts, and/or the like. The memory may also store one or more client applications that are configured to receive, forward, and/or provide content, from and/or to another computing device. The term “mobile device,” as used herein, may be a cellular phone, a personal digital assistant (PDA), a portable email device (e.g., a Blackberry®), a portable media player (e.g., an IPod Touch®), or any other device having communication capability to connect to the network 110. Similar to the general-purpose computer, the mobile device typically includes a processing unit, a memory, a power supply, one or more network interfaces, a display, a keypad or a keyboard, and other input/output interfaces. The mobile device may also include a Global Positioning System (GPS) receiver and/or other location determination device. The mobile device may store and/or execute client applications with the same or similar functionality as those stored on the memory of the general-purpose computer. The mobile device connects to the network using, for example, one or more cellular transceivers or base station antennas (in cellular implementations), access points, terminal adapters, routers or modems (in IP-based telecommunications implementations), or combinations of the foregoing (in converged network embodiments).

The gateway 122 may be any network element capable of network communications. The gateway 122 is coupled to the network 110 enabling communication between the expertise server 140 and the client devices 120A-N. The gateway 122 may be implemented in hardware and/or software in combination with either or both of the expertise server 140 and the client devices 120A-N or as a standalone system. For example, the gateway 122 may be implemented as a software program executing on one or more computer systems forming a portion of a client device (e.g., the client device 120A). Alternatively, the gateway 122 may be implemented as a hardware adapter for and/or a software module executed by the expertise server 140, which is in communication with the client devices 120A-N. The gateway 122 may include an adapter device serving as an interface to the client devices 120A-N in order to facilitate communication between the client devices 120A-N and the expertise server 140. The gateway 122 may be configured to collect user activity information on the client devices 120A-N over the network 110. For example, when a user, using the client device 120A, executes a web browser to visit webpages, connection to every webpage via the network 110 is routed through the gateway 122, such that the user activities and associated information are recorded by the gateway 122 and communicated to the expertise server 140.

The various knowledge databases 130A-N store human learning information utilized by components of the expertise server 140 for operating the knowledge expertise platform. The knowledge databases 130A-N may be third-party knowledge repositories, internal system repositories (e.g., the expertise server's database 206), and the like. The knowledge databases 130A-N include a plurality of databases, where the plurality of databases may originate from the same repository or a plurality of repositories. In one example, the knowledge databases 130A-N are the Wikipedia® repository containing human knowledge across a broad range of topics. In another example, the knowledge databases 130A-N are search engine repositories containing search criteria and results. In yet another example, the knowledge databases 130A-N are the expertise server's databases containing human knowledge acquired from various third-party repositories.

The expertise server 140 may be any combination of software agents and/or hardware modules for running the knowledge expertise platform, either individually or in a distributed manner with other expertise servers 140. Through the expertise server 140, the knowledge expertise platform may providing expertise information to group member users on the client devices 120A-N. Additionally, the knowledge expertise platform may be employed to provide information corresponding to user context on the client devices 120A-N, such as user activities associated with the platform, to the expertise server 140.

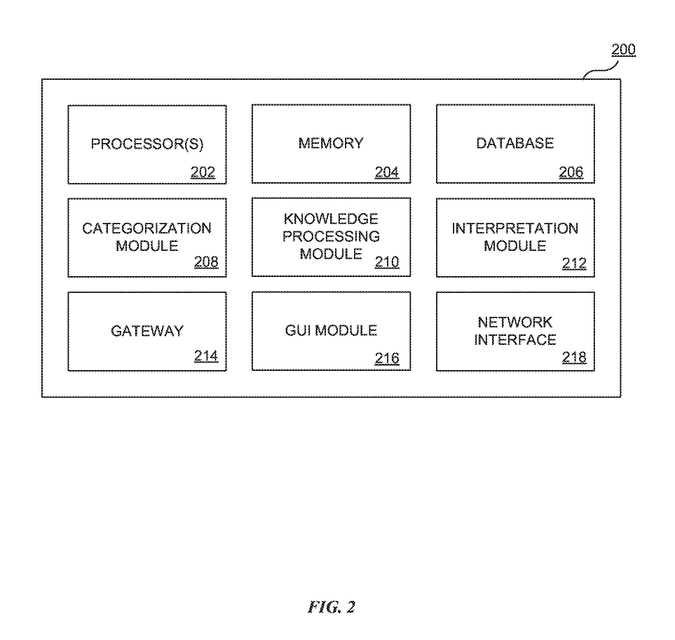

FIG. 2 illustrates an example set of components of the expertise server 200 in accordance with one or more embodiments of the present invention. The expertise server 200 may be the expertise server 140 of FIG. 1. The expertise server 200 may include one or more processors 202, a memory 204, a database 206, a categorization module 208, a knowledge processing module 210, an interpretation module 212, a gateway 214, a GUI module 216, and a network interface 218.

The processor(s) 202 may include central processing units (CPUs) of the server 200 and, thus, control the overall operation of the expertise server 200. The processor(s) 202 is in communication with the memory 204. In some embodiments, the processor(s) accomplish this by executing software or firmware stored in the memory 204. The processor(s) 202 may include one or more programmable general-purpose or special-purpose microprocessors, digital signal processors (DSPs), programmable controllers, application specific integrated circuits (ASICs), programmable logic devices (PLDs), or the like, or a combination of such devices.

The memory 204 includes the main memory of the expertise server 200. The memory 204 represents any form of random access memory (RAM), read only memory (ROM), flash memory, or the like, or a combination of such devices. The memory 204 is operable to store computer readable program instructions for execution by the processor(s) 202. An embodiment of the computer readable program instructions may be arranged in the categorization module 208. Another embodiment of the computer readable program instructions may be arranged in the knowledge processing module 210. Yet another embodiment of the computer readable program instructions may be arranged in the interpretation module 212.

The database 206 is a local database and/or a remote database. The database 206 stores information utilized by components of the expertise server 140 for operating the knowledge expertise platform. In one example, the expertise server 140 stores in the database 206 knowledge information acquired from users of a knowledge expertise platform implemented by the expertise server. Storing the knowledge information may provide access of valuable data to, for example, the interpretation module 212 in order to generate expertise information for the users in return.

The categorization module 208 may be configured to analyze, categorize, and rank knowledge that is representative of the entire universe of human learning (i.e., what humans know). The knowledge may be acquired, for example, from information available in the knowledge databases 130A-N (FIG. 1). The processing performed by the categorization module 208 may, for example, generate knowledge categories, enabling a categorical mapping of the vast amount of information available from the databases 130A-N. The knowledge processing module 210 may be configured to process the knowledge categories in order to establish logical linkages between the knowledge categories. The interpretation module 212 may be configured to analyze “real-world” group knowledge that is representative of the entire enterprise of organizational learning. In particular, the interpretation module may be configured to analyze, for example, the set of knowledge possessed by member users belonging to a user group (e.g., employees within a company). The set of knowledge may be acquired, for example, from interpretation of user content consumption in order to allocate expertise knowledge accurately to the member users (e.g., attribute areas of expertise to particular members) and to share the expertise knowledge among the member users. The interpretation module 212 may be coupled to the categorization module 208 and the knowledge processing module 210 so as to provide empirical backing to the knowledge systems of both the universe of human learning and the organizational world of user “real-world” knowledge.

The gateway 214 may be the gateway 122 of FIG. 1. The gateway 214 may be configured for facilitating collection of user activity information and delivering expertise information between the expertise server 140 and the client devices 120A-N. In one example, the gateway 214 collects user activity on the client device 120A (e.g., content being consumed by the user while navigating through webpages) and subsequently transmits that information to be interpreted by the interpretation module 212. The interpretation module 212, for example, may interpret the content consumed, analyze the behavior trends associated with the user's content consumption, determines appropriate similar topics associated with the consumed content, and transmits expertise information to the client device 120A via the gateway 214.

The Graphical User Interface (GUI) module 214 may be deployed on the client devices 120A-N for enabling communication between the expertise server 140 and the client device users. In one example, when a client device user is working on a topic using the client device 120A, the expertise server 140, upon detecting such user activity and associated information (e.g., topic of the work), can employ the GUI module to display on the client device a list of experts specializing in that topic to assist the user. In such example, the list of experts is derived from expertise information interpreted by the interpretation module 212 and delivered to the GUI module via the gateway 214.

The categorization module 208, the knowledge processing module 210, and the interpretation module 212, the GUI module 216 are preferably executed by the processor(s) 202.

The network interface 218 includes one or more of a modern or network interface. The interface may include an analog modem, isdn modem, cable modem, token ring interface, satellite transmission interface, or other interfaces for coupling a computer system to other computer systems. For example, the network interface may be coupled to the gateway 214 to communicate with the client devices 120A-N.

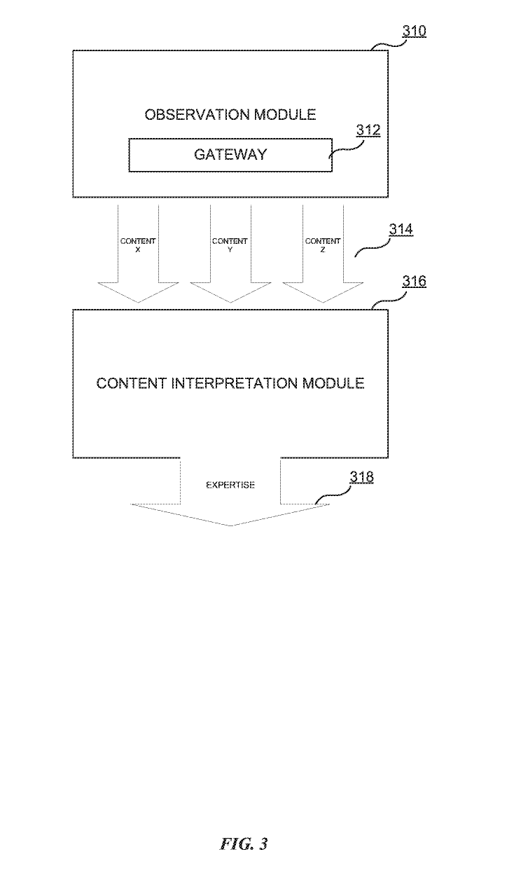

FIG. 3 illustrates an example set of components of an interpretation module 300 in accordance with one or more embodiments of the present invention. The interpretation module 300 may be the interpretation module 212 of FIG. 2. The interpretation module 300 may be executing, for example, on the knowledge expertise platform for delivering expertise information to member users within a user group. As will be discussed in detail herein, the knowledge expertise platform, via the interpretation module 212 enables the collection and the analysis of expertise knowledge possessed by the users in the group, and enables the sharing of that expertise knowledge among the group users in an automated, passive manner. In embodiments, the knowledge expertise platform operates automatically in the background of the user's working environment, enabling the functionalities of the interpretation module 212 to be carried out without interrupting the user. For example, the knowledge expertise platform may be implemented as a JAVA plug-in to a web browser used by the member user. In the example, the platform is able to acquire information associated with the member user's expertise knowledge (e.g., corporate experience) while the user is able to carry on work tasks without any interruption (e.g., being stopped to take a survey for assessing the user's expertise skillsets).

Referring to the illustration in FIG. 3, the interpretation module 300 includes an observation module 310 and a content interpretation module 316. The observation module 310 may be configured to monitor a user's activities on a client device and/or send requests for content information associated with the user's activities. Additionally, the observation module 310 may be configured to receive inputs (e.g., content information) from multiple sources. The input sources may include a gateway 312 facilitated by the observation module 310. The gateway 312 may be the gateway 122 of FIG. 1. The gateway 312 may be configured to communicate content information associated with a client device user as inputs to the interpretation module 300, via the observation module 310, in a continuous, passive manner. The term “passive” as used herein refers to non-disruptive communication between the client device and the interpretation module 300, where user activities on the client device are not interrupted due to the gateway's collection of content information. In the same continuous, passive manner, expertise information may be returned to the client device via the gateway 312 based on the inputs received (i.e., collected content information).

In some embodiments, the inputs provided by the gateway 312 include content information associated with user activity on the client device over a network. In one example, the content information is content being consumed by the client device user, such as articles being read on a webpage, search criteria being submitted on a search engine, profile information submitted to various social network groups, and the like. From the content information, the interpretation module, via the content interpretation module, is able to interpret and deliver to the user a list of experts skilled in a topic associated with, for example, the user's search criteria.

In embodiments, the inputs are collected continuously over a period of time to provide content consumption behaviors of the user. The content consumption behaviors may include, for example, repeated interaction with a particular website, where such repeated interaction may be interpreted as being a high interest in a particular topic. In another example, the inputs include information associated with a user activity for setting up a profile on a social network. In the example, the user may be setting up several social network profiles over a period of time, in which the gateway 312 may continue collecting and sending to the observation module 310. The observation module 310, in turn, may compile the three sets of profile data (e.g., content x, content y, and content z) and transmit the content 314 to the content interpretation module 316 for analysis.

The content interpretation module 316 may be configured to interpret and select appropriate knowledge expertise content for delivery to the user based on the content 314 received from the observation module 310. In some instances, the content interpretation module dynamically generates and returns expertise information to the user. In one example, based on content consumption behaviors of the user (e.g., constant searching for information on topic A using a web search engine), the interpretation module 316 sends a list of experts in the area of topic A to the client device. The GUI module 216 generates for display on the client device a list of the user's coworkers with expertise on topic A.

In other instances, the content interpretation module 316 merely continues analyzing the content 314 received from the observation module 310 without returning any expertise information to the user. In one example, the content interpretation module 316 receives the content 314 belonging to a plurality of member users operating within the knowledge expertise platform. Using the content 314, the module 316 assesses “what the users know.” The module 316, for example, determines what the plurality of users already “know,” are still “learning,” and/or are ignoring based on the content 314. Additionally, the module 316 may analyze the content 314 to establish linkages between successive content (e.g., successive articles being read by users) from related knowledge areas. The analysis findings based on the content 314 assist in allocating expertise among the member users of the group. For example, with enough content 314 acquired over time, the context interpretation module 316 is able to accurately identify certain experts from the plurality of users who have a vast amount of knowledge on certain topics. Additionally, the module 316 may rank the experts among the experts in its analysis. This information, in turn, may be utilized by the interpretation module 316 to generate relevant expertise information for other users looking for information on the certain topics. In some embodiments, the content interpretation module 316 stores the analysis findings in an expertise database associated with the plurality of users of the member group. The expertise database may be the database 206 of FIG. 2. The content interpretation module 316 dynamically updates the expertise database upon receiving newly received content 314 for the plurality of users of the user group. The dynamically updated findings may be utilized, for example, to update the display of experts generated to assist particular users in their work (e.g., enabling a conversation to start with a coworker who knows information about a specific topic).

In some embodiments, the analysis findings may be utilized to generate analytics and reporting features. For example, the analysis findings may form the basis for reports that showcase and/or map skills possessed by employees within a large corporation. In another example, the analysis findings may be used to track improvements and/or gained expertise by employees within the large corporation.

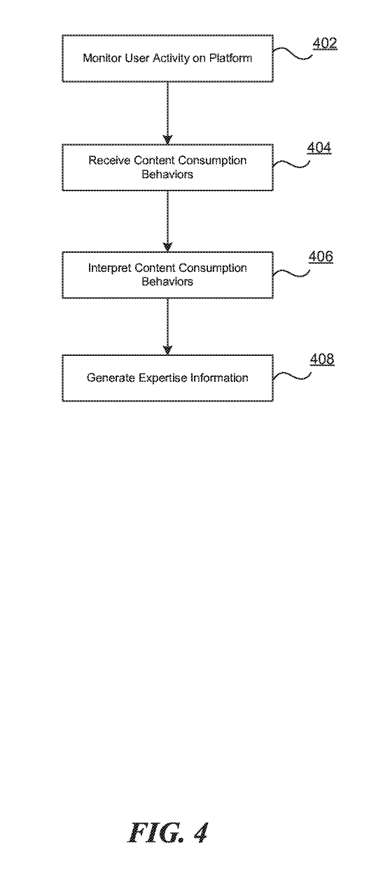

FIG. 4 is a flow diagram illustrating an example process 400 utilized by the interpretation module in accordance with one or more embodiments of the present invention. As discussed above, in some embodiments, the expertise server, implementing a knowledge expertise platform on a client device, monitors user activity on the client device, and subsequently returns expertise information based on the user activity. In particular, the expertise server utilizes the interpretation module including the observation module and the content interpretation module for carrying out functionalities of the knowledge expertise platform.

In one embodiment, the content interpretation module is configured to utilize a content interpretation algorithm for analyzing the content consumption (and associated behaviors) received from the observation module. As discussed above, the content interpretation module plays a vital role in allocating (or attributing) knowledge expertise among member users and in generating relevant expertise information to member users within the user group. In embodiments, the algorithm utilized by the content interpretation module is an enhanced human-genetic based algorithm (or simply, “HGBA”). Traditionally, the HGBA is democratic-based, in the sense that it categorizes ideas and knowledge based on a majority. For example, under the traditional model, concepts shared among four individuals serve as the expertise model for the lone fifth individual. In contrast, the embodiment of the present invention utilizes an enhanced HGBA (or simply, “eHGBA”) to allow for a meritocracy-based model. Under the meritocracy-based model, the lone fifth individual, for example, may serve as the model for the other four individuals. The meritocracy-based model evaluates the quantity and quality of the concepts possessed by the one lone individual, and if that individual has more expertise in a specific area than the other four combined, then that individual serves as the expert model. The meritocracy-based model operates dynamically, taking into consideration the flow in knowledge between the parties involved in the model (e.g., all five individuals). As a result, a non-expert at one point in time, for example, may become an expert at a later time.

The content interpretation module utilizes the eHGBA to analyze the collected content consumption behaviors of the user. In particular, content consumption behaviors of all users within a group (e.g., a company, an organization, etc.) are analyzed in order to derive expertise information from the group members. That information is returned, dynamically, to particular group members (i.e., users of the knowledge expertise platform), in response to new content consumption behavior received by the interpretation module. For example, an organization comprises ten employees, with X specializing on topic X, Y on topic Y, and Z on topic Z. Through monitoring and receiving content consumption behaviors (e.g., various work projects conducted on client devices) of all ten employees, the knowledge expertise platform is able to identify X, Y, and Z as experts in their respective areas. Additionally, through monitoring and receiving content consumption behaviors of A, a coworker who is searching via Google® for information on topic Z, the knowledge expertise platform is able to respond selectively to A based on A's behaviors, and display to A the name of Z and his/her Z specialty. It is noted here that the expertise information is dynamically generated based on both A's content consumption and A's coworkers' content consumption, such that at another point in time X may be displayed instead of Z (i.e., if X gains more knowledge on topic Z).

Referring to step 402, the process 400 starts by monitoring user activity on the knowledge expertise platform. In particular, the process monitors and collects content information associated with the user activity. The content information may be, for example, behaviors associated with the user's consumption of content while using the client device (or simply, “content consumption behaviors”). The content consumption behaviors may include mechanical inputs and non-mechanical inputs from the user. In one example, the mechanical inputs are mouse clicks of the user (e.g., selection of a link on a webpage). In one example, the non-mechanical inputs are mouse movements of the user (e.g., hovering over a link, time spent on a webpage for reading, etc.). In embodiments, the content consumption behaviors are captured from the client device through a gateway, such as the gateway 122 of FIG. 1. The captured content consumption behaviors are sent to the interpretation module, and more particularly to the content interpretation module to be analyzed.

At step 404, the content consumption behaviors are received by the expertise server. At step 406, the content consumption behaviors are interpreted and analyzed to extract expertise information and/or to return expertise information. As discussed above, the content consumption behaviors may be utilized to add on to a knowledge expertise database associated with a group (i.e., knowledge expertise of all group members) employing the eHGBA. The content consumption behaviors may also be utilized to dynamically assist a particular member user by effortlessly offering one or more experts who may be able to know what the member user is looking for. At step 408, the expertise information, based on the content consumption behaviors detected from the member user's activity, is generated.

In some embodiments, the expertise information may be a consolidation of information collected on a particular member user. The consolidated content includes contents associated with the user but originating from different sources. In an illustrative example, the user may have four profiles on four different social networks. Profile information associated with each social network is observed and collected by the expertise server. The expertise server analyzes the profile information from all four social networks and consolidates into one set of profile information. When the user has to migrate from one network to create a new network, the consolidated information is generated to assist in populating profile information on the new network. The user's investment in the previous four profiles are seamlessly transferred over to the new profile with the assistance of the expertise server. It is noted that the consolidation may be implemented for different types of networks, including organizational networks (e.g., a closed, company employee only community network) in addition to social networks (e.g., LinkedIn, Jive, Jammer, etc.).

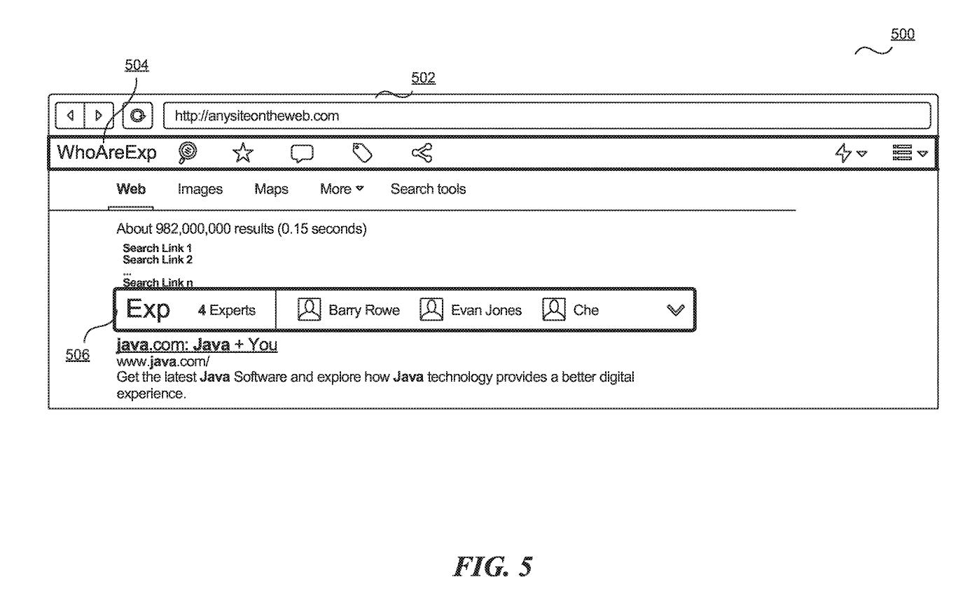

FIG. 5 is an example illustrating a knowledge expertise platform 500 on which a client device may connect to the expertise server in accordance with one or more embodiments of the present invention. In the illustration, the knowledge expertise platform 500 is integrated with a website 502. The integration can be seen by the “WhoAreExp” information toolbar 504. In the illustrated example, a user on a client device (e.g., laptop, PC, mobile device) launches a web browser to access the website 502 looking for information associated with a particular work topic. The user is able to navigate the website 502 without any interruption from the integrated the knowledge expertise platform 500. Content information associated with the user's activity (i.e., content consumption behaviors), however, is monitored and collected by the knowledge expertise platform. In particular, the knowledge expertise platform is able to interpret that the user is working on a particular topic based on the content of the website the user is browsing, the user's mouse activities (e.g., clicking on certain links), and additional content information received.

Based on the content information received, the knowledge expertise platform searches its expertise database, which contains analyzed content consumption behaviors collected from a plurality of users within the user's group. Analyzing the user's content information and the information in the expertise database, the knowledge expertise platform returns to the user relevant expertise information. The relevant expertise information may be in the form of a list of experts who may be able to assist the user with the work topic. As illustrated, the list of experts 506 is presented to the user in a non-intrusive way, appearing on the webpage without requiring any action from the user. The list of experts 506 may be dynamically updated based on newly received content information (i.e., content consumption behaviors) from the user and the plurality of users, such that an expert displayed to the user at t₁ may differ from the expert displayed at t₂. The change in expert may be due to the user's change in direction of his work (e.g., no longer looking for topic A). The change in expert may also be due to the plurality of users' skillsets (e.g., X has just completed an online course on topic A, superseding Y as the expert on topic A).

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference in their entireties. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

We claim:

1. An expertise server comprising:
a processor;
a memory coupled to the processor;
a gateway component coupled to the processor and configured to facilitate network communications,
wherein the gateway component is further configured to collect client device use data of a plurality of users and send the client device use data to an observation component, and
wherein the gateway component being configured to collect the client device use data includes being configured to collect website content or knowledge database content routed via the gateway component to client devices associated, respectively, with the users;
a storage device coupled to the processor,
wherein the storage device includes a knowledge database that includes human learning information, whereby the knowledge database content is content of the knowledge database;
a categorization component coupled to the processor,
wherein the categorization component is configured to generate a plurality of knowledge categories based on an analysis of the human learning information;
a knowledge processing component coupled to the processor,
wherein the knowledge processing component is configured to generate linkages between related knowledge categories based on an analysis of the knowledge categories;
an observation component coupled to the processor,
wherein the observation component is configured to monitor use by the users of the client devices, and
wherein being configured to monitor the use by the users of the client devices includes being configured to monitor the client device use data; and
a content interpretation component coupled to the processor,
wherein the content interpretation component is configured to analyze the client device use data to determine expertise knowledge of each of the users, and
wherein being configured to analyze the client device use data includes being configured to analyze the website content or the knowledge database content.

2. The expertise server of claim 1, wherein any of the gateway component, the categorization component, the knowledge processing component, the observation component, or the content interpretation component comprise a hardware component.

3. The expertise server of claim 2, wherein the gateway component, the categorization component, the knowledge processing component, the observation component, and the content interpretation component each comprise a portion of the hardware component.

4. The expertise server of claim 1, wherein any of the gateway component, the categorization component, the knowledge processing component, the observation component, or the content interpretation component comprise a software component.

5. The expertise server of claim 4, wherein the software component is coupled to the processor when a logical connection that enables the processor to execute instructions of the software component exists between the software component and the processor.

6. The expertise server of claim 1, wherein at least one of the gateway component, the categorization component, the knowledge processing component, the observation component, or the content interpretation component comprise a software component, and wherein at least one of the gateway component, the categorization component, the knowledge processing component, the observation component, or the content interpretation component comprise a hardware component.

7. The expertise server of claim 1, wherein the memory stores instructions which, when executed by the processor, cause the expertise server to perform operations including:
executing a content interpretation algorithm to analyze the client use data to determine the expertise knowledge of each of the users and to select one of the users as an expert model for a particular expertise.

8. The expertise server of claim 7, wherein the content interpretation algorithm is a human-genetic based algorithm (HGBA) that evaluates the expertise knowledge of each of the users to determine which of the users to select as the expert model for the particular expertise.

9. The expertise server of claim 8, wherein the processor when executing the HGBA analyzes knowledge flow between the users to determine to change, based on the knowledge flow, the selection of the expert model from a first user to a second user.

10. The expertise server of claim 8, wherein the processor when executing the HGBA analyzes content consumption behaviors of the users to derive expertise information from the users, the operations further including:
in response to a new content consumption behavior exhibited by a particular user, sending the expertise information to the particular user.

11. An expertise server comprising:
a processor;
a memory coupled to the processor;
a storage device coupled to the processor,
wherein the storage device includes a knowledge database that includes human learning information;
a categorization component coupled to the processor,
wherein the categorization component is configured to generate a plurality of knowledge categories based on an analysis of the human learning information;
a knowledge processing component coupled to the processor,
wherein the knowledge processing component is configured to generate linkages between related knowledge categories based on an analysis of the knowledge categories;
an interpretation component coupled to the processor,
wherein the interpretation component is configured to collect expertise data associated with a plurality of users and analyze the expertise data to determine expertise knowledge of the plurality of users;
a gateway component coupled to the processor,
wherein the interpretation component includes the gateway component,
wherein the gateway component is configured to collect client device use data of the users, and
wherein the gateway component being configured to collect the client device use data includes being configured to collect content of a website or the knowledge database routed via the gateway component to any of the client devices;
an observation component coupled to the processor,
wherein the interpretation component includes the observation component,
wherein the observation component is configured to monitor use by the users of the client devices, and
wherein being configured to monitor the use by the users of the client devices includes being configured to monitor the client device use data; and
a content interpretation component coupled to the processor,
wherein the interpretation component includes the content interpretation component,
wherein the content interpretation component is configured to analyze the client device use data to determine expertise knowledge of each of the users, and
wherein being configured to analyze the client device use data includes being configured to analyze the content of the website or the knowledge database.

12. The expertise server of claim 11, wherein the memory stores instructions which, when executed by the processor, cause the expertise server to perform operations including:
monitoring content consumption behaviors of a user,
wherein the monitoring of the content consumption behaviors include monitoring mouse clicks by the user and mouse movements of the user.

13. The expertise server of claim 12, wherein the monitoring of the mouse movements of the user includes monitoring when the mouse movements cause a cursor to hover over a hyperlink, or include monitoring an amount of time that the cursor hovers over a webpage.

14. The expertise server of claim 11, wherein the memory stores instructions which, when executed by the processor, cause the expertise server to perform operations including:
obtaining profile data of a particular user at a plurality of social networks;
analyzing the profile data to create a consolidated profile; and
generating new profile data for the user at a new social network based on the consolidated profile.

15. The expertise server of claim 14, wherein the social networks include an organizational network with members comprising members or employees of an organization that manages the organizational network.
